(19) United States
(12) Patent Application Publication
(10) Pub. No.: US 2009/0109383 A1
(43) Pub. Date: Apr. 30, 2009

(54) Micro-display

(76) Inventors: Huai-Hsuan Tsai, Tai-Nan City (TW); Yi-Tyng Wu, Chia-I City (TW)

Correspondence Address: NORTH AMERICA INTELLECTUAL PROPERTY CORPORATION, P.O. BOX 506, MERRIFIELD, VA, 22116, US

(21) Appl. No.: 11/933,145

(22) Filed: Oct. 31, 2007

(51) Int. Cl. G02F 1/1335

(52) U.S. Cl. 349/106

(57) ABSTRACT

A structure of a micro-display is provided. The micro-display structure includes a substrate and pixel regions defined on the substrate; a dielectric layer is disposed on a surface of the substrate; a light absorbent layer is positioned on the dielectric layer; and inorganic dichroic layers which are corresponding to each of the pixel regions positioned on the light absorbent layer, respectively.

### BACKGROUND OF THE INVENTION

1. Field of the Invention

The present invention provides a structure of a micro-display, and more particularly, to a structure of a micro-display which utilizes an inorganic dichroic layer and a light absorbent layer to implement the color separation function.

2. Description of the Prior Art

Micro-display is a type of display used in rear-projection projectors or televisions, which are different from the traditional cathode-ray tube TVs. It refers primarily to the displays having technologies such as the Digital Light Processor (DLP), Liquid Crystal Display (LCD), or the Liquid Crystal on Silicon (LCoS), etc, being combined with optical engines for producing amplified images and then to project the images onto a screen.

In general, the LCD is categorized as a transmissive display because light is transmitted through the display panel during use. The LCoS display and the DLP display are categorized as reflective displays because they employ a reflective technology for reflecting light to produce images. Besides, the aforesaid micro-displays are also classified into a three-panel type and a single-panel type according to the number of display panels being used. The optical engine used in the three-panel type displays must be incorporated with the color separation and color combination functions so as to divide the light source into a red light beam, a green light beam, and a blue light beam by using reflectors, dichroic mirrors, prisms, condensing lenses, etc, and then to project the different light beams to three different display panels, respectively, and to combine the three colored light beams reflecting from the different display panels to form a composite full-color image. Consequently, the three-panel type micro-display using the optical engine possesses more complicated light paths; therefore, a larger volume and more expensive cost are resulted.

On the other hand, the single-panel type micro-displays have become more popular, since only one single panel is required to be used. Single-panel micro-display can be roughly classified into of two types, namely a color wheel and a color filter, according to the color separation mechanisms.

The micro-display using color wheel, such as DLP, etc, utilizes a high-spinning color wheel to separate a uniform light source into a red light beam, a green light beam, and a blue light beam, and to project these three color light beams sequentially to a Digital Micromirror Device (DMD). The red, green, and blue images are thus displayed sequentially at a sufficiently high rate that the observer sees a composite full-color image due to persistence of vision. However, the micro-display with the color wheel has the disadvantages such as non-uniform light source distribution, lower resolution, and prone to rainbow effects, etc. Furthermore, the micro-display using the color wheel requires the color wheel system to perform the color separation function, and thereby increases cost and design difficulties.

As to the micro-display using color filter, a plurality of color filters are positioned on the substrate of the corresponding display panel, so as to separate the light source into red, green, and blue light beams. These light beams are then reflected by the LCoS display panel or transmitted through the LCD panel to form a full-color projection image. Because the LCoS display has integrated semiconductor manufacturing with the LCD technology, it possesses the features of higher resolution, higher brightness, simpler structure, and lower cost. Therefore the LCoS display has greater potential in the development of digital projection technologies.

Please refer to FIG. 1, which is a shematic diagram of a conventional LCoS display panel using color filters. As shown in FIG. 1, the LCoS display panel includes a substrate 100, a plurality of pixel electrodes 102, which are arranged in an array, positioned on the substrate 100, a reflective layer 104 disposed on the pixel electrodes 102, and a plurality of color filters 106 corresponding to the pixel electrodes 102 arranged in an array positioned on the reflective layer 104. The LCoS display further includes a top panel 116 disposed in parallel and above the substrate 100, a liquid crystal layer 110 interposed between the substrate 100 and the top panel 116, and a transparent conductive layer 114 disposed on the surface of the top panel 116 facing the substrate 100. In addition, the LCoS display includes a top alignment layer 112 on the surface of the transparent conductive layer 114, and a bottom alignment layer 108 positioned on the surface of the color filters 106 for controlling the alignment direction of the liquid crystal molecules in the liquid crystal layer 110.

The substrate 100 is a silicon substrate, and includes a plurality of metal oxide semiconductor (MOS) devices (not shown) for driving each pixel electrode 102. The reflective layer 104 is made of aluminum, and is used to reflect the incident light after filtered by the color filter 106. The top panel 116 is a transparent panel, such as a glass panel or a quartz panel. The color filters 106 are organic chemical compounds which are manufactured by mixing acrylic resin along with pigments or dyestuff of different colors, for instance, having color filtering capabilities

Although the single-panel LCoS display possesses advantages such as reduced size, lower cost, and simpler design in comparison with displays having three-panel and color wheel, the conventional LCoS display still suffers some shortages. First, the reflective layer of the conventional LCoS is made of aluminum, which has about 80% reflectivity to light beams in the wavelength range of 300 nm to 700 nm; therefore, many unwanted light beams are reflected, so as to influence the quality of the projection image. In addition, the organic color filters have relatively low heat resistance; consequently, they easily suffer degradation after being under extensive accumulated exposure to light beams reflected from the reflective layer. Accordingly, a micro-display structure is provided to improve upon the deficiencies from the prior art.

### SUMMARY OF THE INVENTION

The present invention relates to a micro-display, and more particularly, to a micro-display that utilizes an inorganic dichroic layer and a light absorbent layer for achieving color separation function to overcome the disadvantages of the prior art.

According to the claims, the present invention provides a micro-display. The micro-display comprises a substrate, wherein a plurality of pixel regions are defined on the substrate, a dielectric layer disposed on a surface of the substrate, a light absorbent layer positioned on the dielectric layer, and a plurality of inorganic dichroic layers corresponded to each of the pixel regions positioned on the light absorbent layer, respectively.

The present invention utilizes an inorganic dichroic layer and a light absorbent layer positioned on the substrate to achieve the color separation function; therefore, the problems relating to the reflecting of unwanted light beams to influence the projection image by using a reflective layer in the prior art and the problem relating to reliability of using organic color filters can be solved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is schematic diagram of a conventional LCoS display panel incorporating a color filter.

FIG. 2 is a schematic diagram of a single-panel type LCoS display panel according to a first preferred embodiment of the present invention.

FIG. 3 to FIG. 5 are schematic diagrams of a color separation structure in a single-panel type LCoS display panel according to a second preferred embodiment of the present invention.

FIG. 6 to FIG. 8 are schematic diagrams of a color separation structure in a single-panel type LCoS display panel according to a third preferred embodiment of the present invention.

FIG. 9 is a schematic diagram of a three-panel type LCoS display according to a fourth preferred embodiment of the present invention.

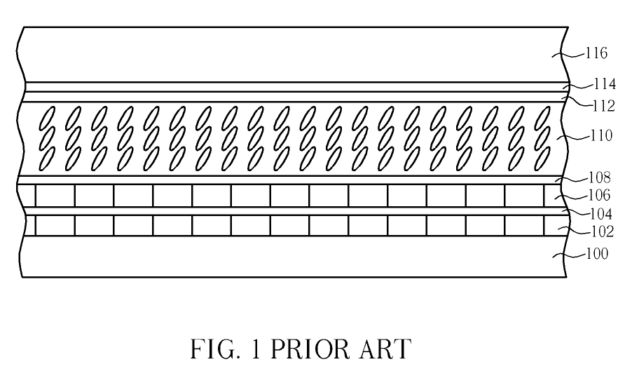

### DETAILED DESCRIPTION

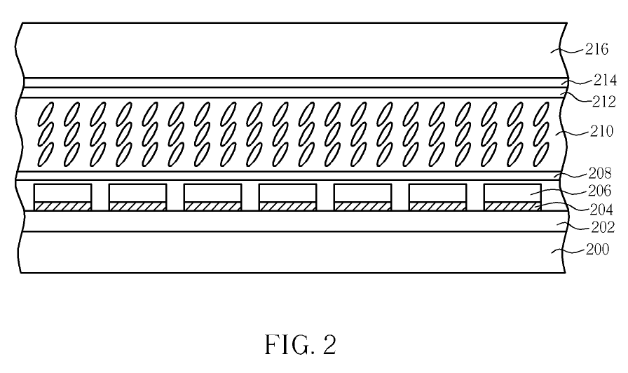

Please refer to FIG. 2, which is a schematic diagram of a single-panel type LCoS display panel according to a first preferred embodiment of the present invention. As shown in FIG. 2, the LCoS display panel includes a substrate 200 and a plurality of pixel regions defined on the substrate 200, a dielectric layer 202 disposed on the substrate 200, a plurality of light absorbent layers 204 arranged in an array and positioned on the dielectric layer 202, and a plurality of inorganic dichroic layers 206 which are corresponding to the light absorbent layers 204 positioned on the light absorbent layers 204, respectively. Furthermore, the LCoS display panel includes a top panel 216 positioned in parallel and above the substrate 200, a liquid crystal layer 210 interposed between the substrate 200 and the top panel 216, and a transparent conductive layer 214 positioned on the surface of the top panel 216 facing the substrate 200. In addition, the LCoS display includes a top alignment layer 212 on the surface of the transparent conductive layer 214, and a bottom alignment layer 208 positioned on the surface of the inorganic dichroic layer 206 for controlling the alignment direction of the liquid crystal molecules in the liquid crystal layer 210. The aforesaid top panel 216 may further include a plurality of optical shielding layers (not shown) positioned between each of the pixel regions for enhancing the contrast and for reducing the cross talk effects.

The substrate 200 is a semiconductor substrate such as a silicon substrate, and includes a plurality of metal oxide semiconductor (MOS) devices (not shown) which are fabricated using standard semiconductor manufacturing processes. The top panel 216 is a transparent panel, such as a glass panel or a quartz panel, etc. The transparent conductive layer 214 is composed of a transparent conductive material such as a transparent conducting oxide (TCO) including such as Indium Tin Oxide (ITO), Indium Zinc Oxide (IZO), Indium Tin Zinc Oxide (ITZO), Aluminum Zinc Oxide (AZO), Zirconium-Zinc oxide (ZZO), and Gallium Zinc Oxide (GZO), etc. The top alignment layer 212 and the bottom alignment layer 208 are used for controlling the alignment direction of the liquid crystal molecules in the liquid crystal layer 210 for precisely control the amount of light transmission.

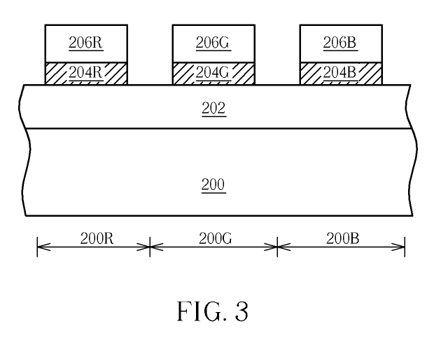

The present invention utilizes the inorganic dichroic layers 206 and the light absorbent layers 204 to achieve the color separation function; therefore, the structure of the inorganic dichroic layers 206 and the light absorbent layers 204 are described below in detail. Please refer to FIG. 3, which is a schematic diagram of a color separation structure in a single-panel type LCoS display panel according to a second preferred embodiment of the present invention. For highlighting the features of the present invention and for clarity of illustration, FIG. 3 merely shows the substrate 200 and includes the inorganic dichroic layers 206 and the light absorbent layers 204 as shown in FIG. 2, where like numerals are used to indicate like elements in FIG. 3 and FIG. 2. Furthermore, FIG. 3 only shows a red pixel region, a green pixel region, and a blue pixel region.

As shown in FIG. 3, the color separation structure includes a substrate 200. A red pixel region 200R, a green pixel region 200G, and a blue pixel region 200B are defined on the substrate 200. The color separation structure further includes a dielectric layer 202 disposed on the substrate 200; three light absorbent layers 204R, 204G, 204B respectively positioned on the dielectric layer 202 in the pixel regions 200R, 200G, 200C; a red dichroic layer 206R, a green dichroic layer 206G, and a blue dichroic layer 206B corresponding to the light absorbent layers 204R, 204G, 204B disposed on the light absorbent layers 204R, 204G, 204B in the pixel regions 200R, 200G, 200C, respectively. Among which, the red dichroic layer 206R, the green dichroic layer 206G, and the blue dichroic layer 206B may be continuous or discontinuous depending on differential process demands.

The light absorbent layers 204R, 204G, 204B are made of a conductive layer, such as titanium nitride (TiN) or tungsten (W), etc. Each light absorbent layer 204R, 204G, 204B has a reflectivity lower than about 60% to the light beams in the wavelength range of 300 nm to 700 nm. According to the second preferred embodiment of the present invention, each light absorbent layer 204R, 204G, 204B is made of titanium nitride and has a thickness of about 500 Å to 1500 Å. It should be noticed that the present invention uses the light absorbent layer in instead of the light reflective layer of the conventional LCoS display panel; therefore, the problem of reflecting unwanted light beams to affect the projection image can be solved. Furthermore, because each light absorbent layer 204R, 204G, 204B of the second preferred embodiment of the present invention is a conductive layer, the light absorbent layers 204R, 204G, 204B in the pixel regions 200R, 200G, 200B can also be used as the corresponding pixel electrodes, respectively. Namely, there is no need to add other pixel electrodes in the LCoS display panel, according to the second preferred embodiment of the present invention. Certainly, the pixel electrodes and the light absorbent layers can be individual devices as shown in another preferred embodiment of the present invention. And the pixel electrodes are set under the light absorbent layers. The detailed content of which will be described later in the third preferred embodiment of the present invention.

In the present preferred embodiment, because the light absorbent layers 204R, 204G, 204B are used as pixel electrodes, the light absorbent layers 204R, 204G, 204B in the pixel regions 200R, 200G, 200B are discontinuous. Namely, the method of forming the discontinuous light absorbent layers 204R, 204G, 204B is to deposit a conductive material (not shown) on the dielectric layer 202 first. An etching process is then carried out to etch the conductive material so as to form spaces between the pixel regions 200R, 200G, 200B. As a result, the corresponding array patterns (i.e. the light absorbent layers 204R, 204G, 204B) are respectively formed in the pixel regions 200R, 200G, 200B. The width of each light absorbent layer 204R, 204G, 204B is not necessarily the same as the width of each dichroic layer 206R, 206G, 206B as is illustrated in FIG. 3. The width of each light absorbent layer 204R, 204G, 204B may be wider or narrower than the width of each dichroic layer 206R, 206G, 206B by using the etching process for adjustment of width.

The dielectric layer 202 can be made of dielectric materials capable of absorbing the incident light beams transmitted through the spaces between the pixel regions 200R, 200G, 200B in order to reduce the cross talk effect between each of the pixel regions 200R, 200G, 200B.

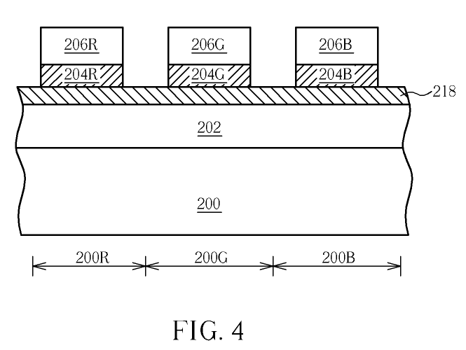

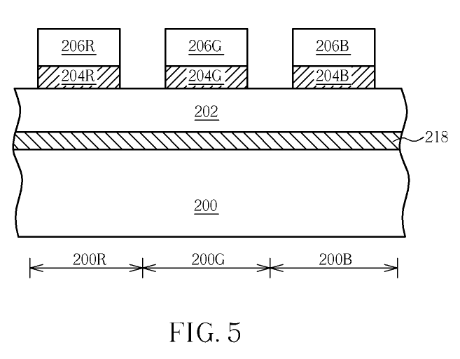

However, the dielectric layer 202 can also be made of dielectric materials, which are not capable of absorbing the incident light beams. In this circumstance, the structure of the present preferred embodiment may further have a bottom light absorbent layer 218 between the dielectric layer 202 and each of the light absorbent layers 204R, 204G, 204B as shown in FIG. 4 in order to absorb the incident light beams transmitted through the spaces between the pixel regions 200R, 200G, 200B. The bottom light absorbent layer 218 may also be disposed between the substrate 200 and the dielectric layer 202 as shown in FIG. 5 in order to absorb the incident light beams transmitted through the spaces between the pixel regions 200R, 200G, 200B. The aforesaid bottom light absorbent layer 218 may be made of the same materials as the light absorbent layers 204R, 204G, 204B.

The red dichroic layer 206R, the green dichroic layer 206G, and the blue dichroic layer 206B in the pixel regions 200R, 200G, 200B are double stacked structures which are stacked using two inorganic layers having significantly different refractivities. The dichroic layer 206R, 206G, 206B may also be alternately stacked structures which are alternately stacked using two inorganic layers having significantly different refractivities. For example, the stacked structures can be stacked or alternately stacked using a titanium oxide (TiO₂) film with a higher refractivity and a silicon oxide (SiO₂) layer film with a lower refractivity; or the stacked structures can be stacked or alternately stacked using a tantalum pentoxide (Ta₂O₅) film with a higher refractivity and a silicon oxide film with a lower refractivity. The red, green, and blue dichroic layers 206R, 206G, 206B can be made to fulfill the different demands for reflecting the light beams within the red, green, and blue wavelength ranges, respectively, by adjusting the stacking order, the number of the stacked films, or the thicknesses of the stacked films of the TiO₂ film/the SiO₂ film or the Ta₂O₅ film/the SiO₂ film.

According to the second preferred embodiment of the present invention, the red dichroic layer 206R, the green dichroic layer 206G, and the blue dichroic layer 206B are alternately stacked structure, which are alternately stacked using TiO₂ film/SiO₂ film or Ta₂O₅ film/SiO₂ film, and having total layer counts of about 15 to 20. In addition, it is determined that the using of the Ta₂O₅ film/SiO₂ film achieves better result. It should be noticed that dichroic layers comprising of other colors, such as cyan, yellow, magenta, etc, are available, and that the invention is not limited to the use of only red, green, and blue dichroic layers.

Accordingly, the red dichroic layer 206R is able to reflect the light beams having a wavelength within the wavelength range of the red visible light, and to allow the light beams having a wavelength beyond the wavelength range of the red visible light to penetrate. Likewise, the green dichroic layer 206G is able to reflect the light beams having a wavelength within the wavelength range of the green visible light, and to allow the light beams having a wavelength beyond the wavelength range of the green visible light to penetrate. Similarly, the blue dichroic layer 206B is able to reflect the light beams having a wavelength within the wavelength range of the blue visible light, and to allow the light beams having a wavelength beyond the wavelength range of the blue visible light to penetrate. Each of the light absorbent layer 204R, 204G, 204B is used to absorb the light beams which have penetrated the red, green, and blue dichroic layers 206R, 206G, 206B.

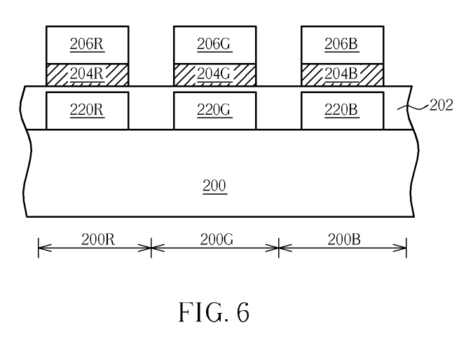

Please refer to FIG. 6, which is a schematic diagram of a color separation structure in a single-panel type LCoS display panel according to a third preferred embodiment of the present invention. For highlighting the features of the present invention and for clarity of illustration, FIG. 6 merely shows the substrate 200 and includes the inorganic dichroic layers 206 and the light absorbent layers 204 as shown in FIG. 2, where like numerals are used to indicate like elements in FIG. 6, FIG. 2, and FIG. 3. Furthermore, FIG. 6 only shows a red pixel region, a green pixel region, and a blue pixel region.

As shown in FIG. 6, the color separation structure includes a substrate 200, and a red pixel region 200R, a green pixel region 200G, and a blue pixel region 200B are defined on the substrate 200. The color separation structure further includes a dielectric layer 202 disposed on the substrate 200; a red pixel electrode 220R, a green pixel electrode 220G, and a blue pixel electrode 220B respectively positioned within the dielectric layer 202 in the pixel regions 200R, 200G, 200B; three light absorbent layers 204R, 204G, 204B respectively positioned on the dielectric layer 202 in the pixel regions 200R, 200G, 200C; and a red dichroic layer 206R corresponding to the red pixel electrode 220R, a green dichroic layer 206G corresponding to the green pixel electrode 220G, and a blue dichroic layer 206B corresponding to the blue pixel electrode 220B positioned on the light absorbent layers 204R, 204G, 204B in the pixel regions 200R, 200G, 200C, respectively. However, the position of the pixel electrodes 220R, 220G, 220B is not limited to be within the dielectric layer 202; the position may also be above the dielectric layer 202 and under the light absorbent layers 204R, 204G, 204B.

The difference between the second preferred embodiment shown in FIG. 3 and the third preferred embodiment is that the light absorbent layers 204R, 204G, 204B shown in FIG. 6 are made of a non-conductive layer. Consequently, there are additional red pixel electrode 220R, green pixel electrode 220G, and blue pixel electrode 220B being set within the dielectric layer 202. These pixel electrode 220R, 220G, 220B may be made of any conductive materials.

It should be noticed that because the light absorbent layer 204R, 204G, 204B according to the third preferred embodiment are made of non-conductive layers, each light absorbent layer 204R, 204G, 204B in the pixel region 200R, 200G, 200B respectively may be discontinuous or continuous. When they are discontinuous, the width of each light absorbent layer 204R, 204G, 204B is not necessarily the same as the width of each dichroic layer 206R, 206G, 206B, and may be wider or narrower than the width of each dichroic layer 206R, 206G, 206B. And under this circumstance, the dielectric layer 202 is made of dielectric materials capable of absorbing the incident light beams in order to absorb the incident light beams transmitted through the spaces between each of the pixel regions 200R, 200G, 200B.

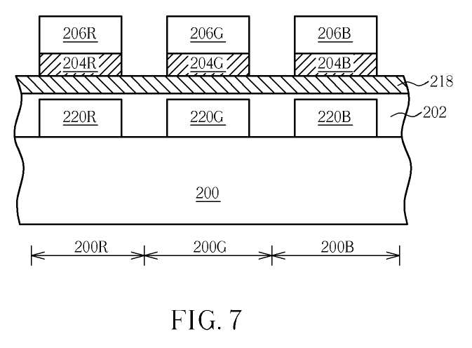

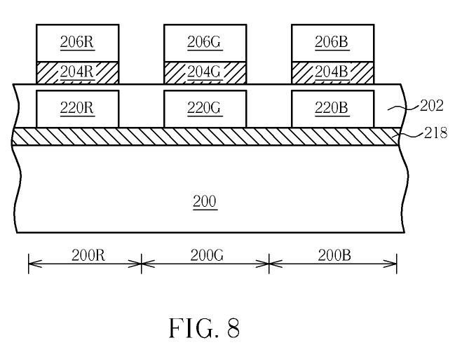

However, the dielectric layer 202 may be made of dielectric materials, which are not capable of absorbing the incident light beams. Under this circumstance, the structure may further have a bottom light absorbent layer 218 between the dielectric layer 202 and each of the light absorbent layers 204R, 204G, 204B as shown in FIG. 7 in order to absorb the incident light beams transmitted through the spaces between each of the pixel regions 200R, 200G, 200B. The bottom light absorbent layer 218 may also be set between the substrate 200 and the dielectric layer 202 as shown in FIG. 8 in order to absorb the incident light beams transmitted through the spaces between the pixel regions 200R, 200G, 200B. The aforesaid bottom light absorbent layer 218 may be made of the same materials as the light absorbent layers 204R, 204G, 204B.

The red dichroic layer 206R, the green dichroic layer 206G, and the blue dichroic layer 206B in the pixel regions 200R, 200G, 200B are double stacked structures which are stacked using two inorganic layers having significantly different refractivities. The dichroic layers 206R, 206G, 206B may also be alternately stacked structures which are alternately stacked using two inorganic films having significantly different refractivities. For example, the stacked structures can be double stacked or alternately stacked using a titanium oxide (TiO₂) film having higher refractivity and a silicon oxide (SiO₂) film having lower refractivity; or the stacked structures can be double stacked or alternately stacked using a tantalum pentoxide (Ta₂O₅) film with higher refractivity and a silicon oxide film with lower refractivity. The red, green, and blue dichroic layers 206R, 206G, 206B can be made to fulfill the different demands for reflecting the light beams within the red, green, and blue wavelength ranges respectively by adjusting the stack order, the number of the stacked films, or the thicknesses of the stacked films of TiO₂ film/SiO₂ film or Ta₂O₅ film/SiO₂ film. It should be noticed that dichroic layers of other colors, such as cyan, yellow, magenta, etc, are also available, and that the invention is not limited to the use of only the red, green, and blue dichroic layers.

Accordingly, the red dichroic layer 206R is able to reflect the light beams having a wavelength within the wavelength range of red visible light, and to allow the light beams having a wavelength beyond the wavelength range of the red visible light to penetrate. Likewise, the green dichroic layer 206G is able to reflect the light beams having a wavelength within the wavelength range of the green visible light, and to allow the light beams having a wavelength beyond the wavelength range of the green visible light to penetrate. The blue dichroic layer 206B is able to reflect the light beams having a wavelength within the wavelength range of the blue visible light, and to allow the light beams having a wavelength beyond the wavelength range of the blue visible light to penetrate. Each of the light absorbent layers 204R, 204G, 204B is used to absorb the light beams which are to penetrate the red, green, and blue dichroic layers 206R, 206G, 206B.

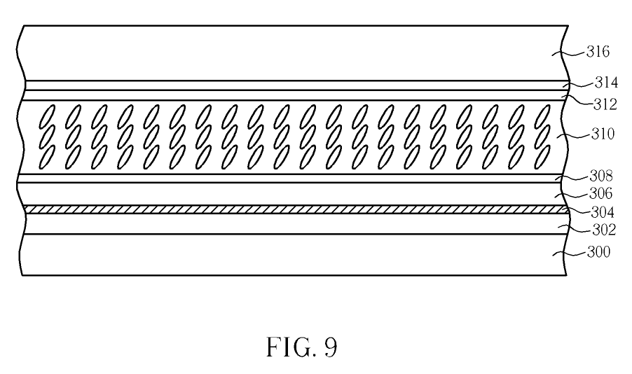

The LCoS display panel described above is applied to a single-panel type LCoS display, and therefore, the substrate includes a plurality of red dichroic layers, a plurality of green dichroic layers, and a plurality of blue dichroic layers. However, the LCoS display panel according to other preferred embodiments of the present invention may also be applied to a three-panel type LCoS display. Referring to FIG. 9, which is a schematic diagram of a three-panel type LCoS display according to the fourth preferred embodiment of the present invention.

As shown in FIG. 9, the LCoS display panel includes a substrate 300, a dielectric layer 302 disposed on the substrate 300, a light absorbent layer 304 disposed on the dielectric layer 302, and an inorganic dichroic layer 306 disposed on the light absorbent layer 304. The LCoS display panel further includes a top panel 316 positioned in parallel and above the substrate 300, a liquid crystal layer 310 interposed between the substrate 300 and the top panel 316, and a transparent conductive layer 314 disposed on the surface of the top panel 316 facing the substrate 300. In addition, the LCoS display includes a top alignment layer 312 on the surface of the transparent conductive layer 314, and a bottom alignment layer 308 disposed on the surface of the inorganic dichroic layer 306 for controlling the alignment direction of the liquid crystal molecules in the liquid crystal layer 310.

The substrate 300 is a semiconductor substrate such as a silicon substrate, and includes a plurality of metal oxide semiconductor (MOS) devices (not shown), which are fabricated using standard semiconductor manufacturing processes. The top panel 316 is a transparent panel, such as a glass panel or a quartz panel. The transparent conductive layer 314 is made of transparent conducting materials such as Indium Tin Oxide (ITO), etc. When the light absorbent layer 304 is made of a conductive layer, the light absorbent layer 304 can be used as a pixel electrode in the LCoS display panel. Therefore, if a common voltage is provided to the transparent conductive layer 314 and a driving voltage is provide to the light absorbent layer 304 at the same time, a voltage difference would be generated between the transparent conductive layer 314 and the light absorbent layer 304 so as to drive the liquid crystal molecules in the liquid crystal layer 310 to rotate. The top alignment layer 312 and the bottom alignment layer 308 make the liquid crystal molecules rotate in predetermined directions so as to accurately control the amount of penetrating light beams. However, if the light absorbent layer 304 is made of a non-conductive layer, it is required to dispose a pixel electrode within the dielectric layer 302 or to disposed a pixel electrode between the dielectric layer 302 and the light absorbent layer 304.

The difference between a single-type LCoS display panel and the LCoS display panel according to the fourth preferred embodiment of the present invention is that the LCoS display panel according to the fourth preferred embodiment of the present invention is being applied to a three-panel type LCoS display; therefore, only one dichroic layer, which reflect light beams having a wavelength within a predetermined wavelength range, and allow light beams having a wavelength beyond the predetermined wavelength range to penetrate, is required to be in the LCoS display panel. For example, if the LCoS display panel is used to provide the red display images, only a stacked structure, which is comprised of double stacked or alternately stacked layers using two inorganic films having significantly different refractivities, is required to reflect the light beams having a wavelength within the wavelength range of the red visible light, and to allow the light beams having a wavelength beyond the wavelength range of red visible light to penetrate. The aforesaid stacked structure can be double stacked or alternately stacked using a titanium oxide (TiO₂) film with a higher refractivity and a silicon oxide (SiO₂) film with a lower refractivity. The stacked structures can also be double stacked or alternately stacked using a tantalum pentoxide (Ta₂O₅) film with a higher refractivity and a silicon oxide film with a lower refractivity. Likewise, if the LCoS display panel is used to provide a green or a blue display image, a dichroic layer can be made of a stacked structure, which is double stacked or alternately stacked using two inorganic films with significantly different refractivities by adjusting the stack order, the number of the stacked films, or the thicknesses of the stacked films. Finally, the red, green, and blue display images projected respectively from the red, green, and blue LCoS display panels are recombined to form a composite full-color image using a color combination system.

The LCoS display panel of the present invention utilizes an inorganic dichroic layer and a light absorbent layer to implement the color separation function. Because the present invention uses a light absorbent layer instead of a reflective layer as used in prior art, the problem relating to the reflecting of unwanted light beams to affect the projection image can be solved. In addition, the light absorbent layer of the present invention can be a conductive layer or a non-conductive layer. If the light absorbent layer is made of a conductive layer, the light absorbent layer can be used as a pixel electrode in a pixel region. Consequently, there is no need to provide another pixel electrode. Finally, the inorganic dichroic layer of the present invention is a stacked structure, which is a double stacked or an alternately stacked using two inorganic films having significantly different refractivities; therefore the problem relating to reliability when using organic color filters can be solved. It should be noticed that the color separation structure in a LCoS display panel of the present invention is not limited to be used in a LCoS display, it can also be used in any three-panel or single-panel projection-type micro-display.

Those skilled in the art will readily observe that numerous modifications and alterations of the device and method may be made while retaining the teachings of the invention.

What is claimed is:

1. A micro-display, comprising:
a substrate, and a plurality of pixel regions defined on the substrate;
a dielectric layer disposed on a surface of the substrate;
a light absorbent layer positioned on the dielectric layer; and
a plurality of inorganic dichroic layers, corresponding to each of the pixel regions positioned on the light absorbent layer, respectively.

2. The micro-display of claim 1, wherein the light absorbent layer is used for absorbing a plurality of light beams penetrating the inorganic dichroic layers.

3. The micro-display of claim 1, wherein the light absorbent layer comprising a reflectivity lesser than about 60% to a plurality of light beams in the wavelength range of about 300 nm to 700 nm.

4. The micro-display of claim 1, wherein the light absorbent layer is a conductive layer.

5. The micro-display of claim 4, wherein the light absorbent layer further comprises a plurality of array patterns corresponding to each of the pixel regions, respectively, and each array pattern is used as a pixel electrode, respectively.

6. The micro-display of claim 4, wherein the light absorbent layer comprises titanium nitride (TiN).

7. The micro-display of claim 4, wherein the light absorbent layer comprises tungsten (W).

8. The micro-display of claim 5, wherein the structure further comprises a bottom light absorbent layer disposed between the dielectric layer and the light absorbent layer.

9. The micro-display of claim 5, wherein the structure further comprises a bottom light absorbent layer disposed between the substrate and the dielectric layer.

10. The micro-display of claim 1, wherein the light absorbent layer is a non-conductive layer.

11. The micro-display of claim 10, wherein the dielectric layer further comprising a plurality of pixel electrodes corresponding to each of the pixel regions, respectively.

12. The micro-display of claim 10, wherein the structure further comprises a plurality of pixel electrodes corresponding to each of the pixel regions, respectively, being set between the dielectric layer and the light absorbent layer.

13. The micro-display of claim 10, wherein the light absorbent layer further comprises a plurality of array patterns corresponding to the plurality of pixel regions, respectively.

14. The micro-display of claim 13, wherein further comprising a bottom light absorbent layer disposed between the dielectric layer and the light absorbent layer.

15. The micro-display of claim 13, wherein further comprising a bottom light absorbent layer disposed between the substrate and the dielectric layer.

16. The micro-display of claim 1, wherein each inorganic dichroic layer comprises an alternately stacked structure made of at least a lower refractivity layer and at least a higher refractivity layer.

17. The micro-display of claim 16, wherein the lower refractivity layer comprises a silicon oxide layer.

18. The micro-display of claim 17, wherein the higher refractivity layer comprises a titanium oxide (TiO₂) layer.

19. The micro-display of claim 17, wherein the higher refractivity layer comprises a tantalum pentoxide (Ta₂O₅) layer.

20. The micro-display of claim 1, wherein the inorganic dichroic layers comprise at least a red dichroic layer, at least a green dichroic layer, and at least a blue dichroic layer; and the red, green, and blue dichroic layers reflecting a plurality of light beams comprising a wavelength within a plurality of wavelength ranges of the red, green, and blue visible lights, respectively, and allowing the light beams having a wavelength beyond the wavelength ranges of the red, green, and blue visible lights to penetrate, respectively.

21. The micro-display of claim 1, wherein the inorganic dichroic layers reflect light beams having a wavelength within a predetermined wavelength range, and allow light beams having a wavelength beyond the predetermined wavelength range to penetrate.

22. The micro-display of claim 21, wherein the predetermined wavelength range is a wavelength range of red visible lights.

23. The micro-display of claim 21, wherein the predetermined wavelength range is a wavelength range of green visible lights.

24. The micro-display of claim 21, wherein the predetermined wavelength range is a wavelength range of blue visible lights.

25. The micro-display of claim 1, further comprising:
a top panel, disposed above the substrate;
a transparent conductive layer, disposed on a surface of the top panel facing the substrate;
a liquid crystal layer, filled in between the inorganic dichroic layer and the transparent conductive layer;
a top alignment layer, positioned between the transparent conductive layer and the liquid crystal layer; and
a bottom alignment layer, positioned between the inorganic dichroic layer and the liquid crystal layer, wherein the micro-display is a Liquid Crystal on Silicon (LCoS) display.
